(19) United States
(12) Patent Application Publication
(10) Pub. No.: US 2023/0260023 A1
(43) Pub. Date: Aug. 17, 2023

(54) METHOD AND SYSTEM FOR PREDICTIVE ANALYTICS OF SPECIFIED POOLS

(71) Applicant: JPMorgan Chase Bank, N.A., New York, NY (US)

(72) Inventor: Ravi SHANKAR, Metuchen, NJ (US)

(73) Assignee: JPMorgan Chase Bank, N.A., New York, NY (US)

(21) Appl. No.: 17/650,769

(22) Filed: Feb. 11, 2022

(51) Int. Cl. G06Q 40/04; G06N 5/02

(52) U.S. Cl. CPC G06Q 40/04; G06N 5/02

(57) ABSTRACT

A method for facilitating automated predictive analytics of specified pools is disclosed. The method includes receiving, via an application programming interface, a bid list from an exchange platform, the bid list relating to a listing of the specified pools; parsing the bid list to identify pool characteristics for each of the specified pools; retrieving real-time market data that corresponds to each of the specified pools; aggregating historical trade data that relates to each of the specified pools; determining, by using a model, a predicted amount for each of the specified pools based on the identified pool characteristic, the retrieved real-time market data, and the aggregated historical trade data; and outputting, via the application programming interface, the predicted amount to the exchange platform.

### BACKGROUND

### 1. Field of the Disclosure

This technology generally relates to methods and systems for predictive analytics, and more particularly to methods and systems for facilitating automated predictive analytics of specified pools by using machine learning and artificial intelligence.

### 2. Background Information

Many financial institutions engage in the transaction of complex financial instruments. Often, the complex financial instruments represent various assets that are grouped into pools such as, for example, specified pools. Historically, implementations of conventional techniques for analyzing the complex financial instruments have resulted in varying degrees of success with respect to analytical efficiency and predictive accuracy.

One drawback of using the conventional techniques is that in many instances, the complex financial instruments represent assets that are affected by real-world variables and market conditions. As a result, analyzing large numbers of complex financial instruments require large investments in time and processing capabilities. Additionally, predictive accuracy, which relies on detailed modeling of the real-world variables and the market conditions, suffers due to the complexity of the financial instruments.

Therefore, there is a need to facilitate predictive analytics of complex financial instruments by using machine learning and artificial intelligence to accurately make predictions in real-time by leveraging nuanced characteristics and historical data.

### SUMMARY

The present disclosure, through one or more of its various aspects, embodiments, and/or specific features or sub-components, provides, inter alia, various systems, servers, devices, methods, media, programs, and platforms for facilitating automated predictive analytics of specified pools by using machine learning and artificial intelligence.

According to an aspect of the present disclosure, a method for facilitating automated predictive analytics of a plurality of specified pools is disclosed. The method is implemented by at least one processor. The method may include receiving, via an application programming interface, at least one bid list from at least one exchange platform, the at least one bid list may relate to a listing of at least one specified pool; parsing the at least one bid list to identify at least one pool characteristic for each of the at least one specified pool; retrieving real-time market data that corresponds to each of the at least one specified pool; aggregating historical trade data that relates to each of the at least one specified pool; determining, by using at least one model, a predicted amount for each of the at least one specified pool based on the identified at least one pool characteristic, the retrieved real-time market data, and the aggregated historical trade data; and outputting, via the application programming interface, the predicted amount to the at least one exchange platform.

In accordance with an exemplary embodiment, the at least one specified pool may include a plurality of financial instruments that are combined based on at least one shared attribute, the at least one shared attribute may include at least one from among a credit score attribute, a loan size attribute, and a geographical distribution attribute.

In accordance with an exemplary embodiment, the predicted amount may correspond to a predicted pay-up amount for the corresponding at least one specified pool, the predicted pay-up amount may relate to an estimated premium over a generic to be announced security price.

In accordance with an exemplary embodiment, the method may further include retrieving a transacted amount for the corresponding at least one specified pool, the transacted amount may relate to an actual pay-up amount for the corresponding at least one specified pool in an executed transaction; and generating at least one report based on a predetermined preference, the at least one report may include information that relates to the predicted amount, the transacted amount, and the corresponding at least one specified pool.

In accordance with an exemplary embodiment, the method may further include benchmarking, by using at least one error analysis algorithm, the at least one model based on the predicted amount and the transacted amount, the at least one error analysis algorithm may include at least one from among a mean absolute error algorithm and a root mean squared error algorithm; and updating the at least one report to include a result of the benchmarking.

In accordance with an exemplary embodiment, the method may further include generating feedback data based on a predetermined parameter, the predetermined parameter may include a time parameter; and training the at least one model by using the feedback data.

In accordance with an exemplary embodiment, the feedback data may include information that relates to the predicted amount, a transacted amount, and the corresponding at least one specified pool, the transacted amount may relate to an actual pay-up amount for the corresponding at least one specified pool in an executed transaction.

In accordance with an exemplary embodiment, the predicted amount for each of the at least one specified pool may be automatically determined and outputted in real-time in response to the received at least one bid list.

In accordance with an exemplary embodiment, the at least one model may include at least one from among a machine learning model, a mathematical model, a process model, and a data model.

According to an aspect of the present disclosure, a computing device configured to implement an execution of a method for facilitating automated predictive analytics of a plurality of specified pools is disclosed. The computing device including a processor; a memory; and a communication interface coupled to each of the processor and the memory, wherein the processor may be configured to receive, via an application programming interface, at least one bid list from at least one exchange platform, the at least one bid list may relate to a listing of at least one specified pool; parse the at least one bid list to identify at least one pool characteristic for each of the at least one specified pool; retrieve real-time market data that corresponds to each of the at least one specified pool; aggregate historical trade data that relates to each of the at least one specified pool; determine, by using at least one model, a predicted amount for each of the at least one specified pool based on the identified at least one pool characteristic, the retrieved real-time market data, and the aggregated historical trade data; and output, via the application programming interface, the predicted amount to the at least one exchange platform.

In accordance with an exemplary embodiment, the at least one specified pool may include a plurality of financial instruments that are combined based on at least one shared attribute, the at least one shared attribute may include at least one from among a credit score attribute, a loan size attribute, and a geographical distribution attribute.

In accordance with an exemplary embodiment, the predicted amount may correspond to a predicted pay-up amount for the corresponding at least one specified pool, the predicted pay-up amount may relate to an estimated premium over a generic to be announced security price.

In accordance with an exemplary embodiment, the processor may be further configured to retrieve a transacted amount for the corresponding at least one specified pool, the transacted amount may relate to an actual pay-up amount for the corresponding at least one specified pool in an executed transaction; and generate at least one report based on a predetermined preference, the at least one report may include information that relates to the predicted amount, the transacted amount, and the corresponding at least one specified pool.

In accordance with an exemplary embodiment, the processor may be further configured to benchmark, by using at least one error analysis algorithm, the at least one model based on the predicted amount and the transacted amount, the at least one error analysis algorithm may include at least one from among a mean absolute error algorithm and a root mean squared error algorithm; and update the at least one report to include a result of the benchmarking.

In accordance with an exemplary embodiment, the processor may be further configured to generate feedback data based on a predetermined parameter, the predetermined parameter may include a time parameter; and train the at least one model by using the feedback data.

In accordance with an exemplary embodiment, the feedback data may include information that relates to the predicted amount, a transacted amount, and the corresponding at least one specified pool, the transacted amount may relate to an actual pay-up amount for the corresponding at least one specified pool in an executed transaction.

In accordance with an exemplary embodiment, the processor may be further configured to automatically determine and output the predicted amount for each of the at least one specified pool in real-time in response to the received at least one bid list.

In accordance with an exemplary embodiment, the at least one model may include at least one from among a machine learning model, a mathematical model, a process model, and a data model.

According to an aspect of the present disclosure, a non-transitory computer readable storage medium storing instructions for facilitating automated predictive analytics of a plurality of specified pools is disclosed. The storage medium including executable code which, when executed by a processor, may cause the processor to receive, via an application programming interface, at least one bid list from at least one exchange platform, the at least one bid list may relate to a listing of at least one specified pool; parse the at least one bid list to identify at least one pool characteristic for each of the at least one specified pool; retrieve real-time market data that corresponds to each of the at least one specified pool; aggregate historical trade data that relates to each of the at least one specified pool; determine, by using at least one model, a predicted amount for each of the at least one specified pool based on the identified at least one pool characteristic, the retrieved real-time market data, and the aggregated historical trade data; and output, via the application programming interface, the predicted amount to the at least one exchange platform.

In accordance with an exemplary embodiment, the at least one specified pool may include a plurality of financial instruments that are combined based on at least one shared attribute, the at least one shared attribute may include at least one from among a credit score attribute, a loan size attribute, and a geographical distribution attribute.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated predictive analytics of specified pools by using machine learning and artificial intelligence.

FIG. 4 is a flowchart of an exemplary process for implementing a method for facilitating automated predictive analytics of specified pools by using machine learning and artificial intelligence.

FIG. 5 is a screen shot that illustrates a benchmark graphical user interface that is usable for implementing a method for facilitating automated predictive analytics of specified pools by using machine learning and artificial intelligence, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

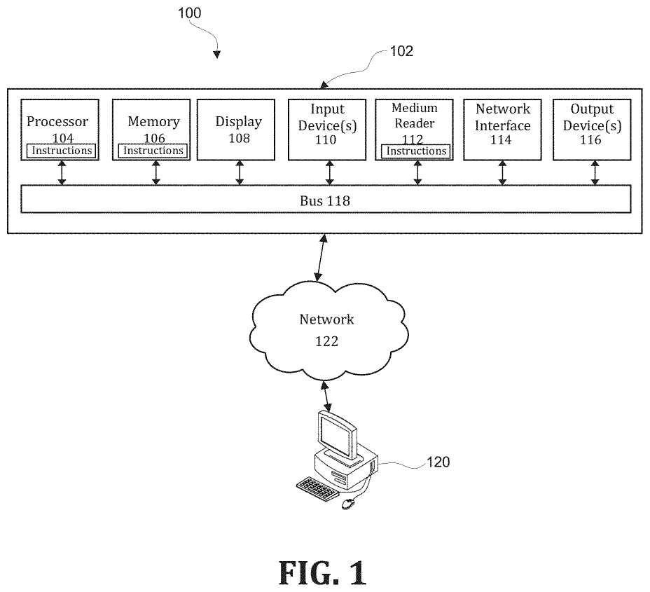

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated predictive analytics of specified pools by using machine learning and artificial intelligence.

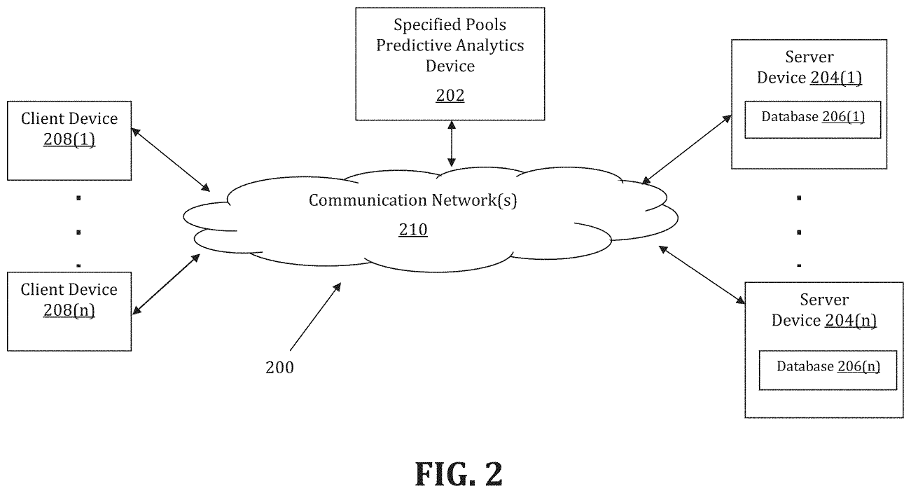

Referring to FIG. 2, a schematic of an exemplary network environment 200 for implementing a method for facilitating automated predictive analytics of specified pools by using machine learning and artificial intelligence is illustrated. In an exemplary embodiment, the method is executable on any networked computer platform, such as, for example, a personal computer (PC).

The method for facilitating automated predictive analytics of specified pools by using machine learning and artificial intelligence may be implemented by a Specified Pools Predictive Analytics (SPPA) device 202. The SPPA device 202 may be the same or similar to the computer system 102 as described with respect to FIG. 1. The SPPA device 202 may store one or more applications that can include executable instructions that, when executed by the SPPA device 202, cause the SPPA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SPPA device 202 itself, may be located in virtual server(s) running in a cloud-based computing environment rather than being tied to one or more specific physical network computing devices. Also, the application(s) may be running in one or more virtual machines (VMs) executing on the SPPA device 202. Additionally, in one or more embodiments of this technology, virtual machine(s) running on the SPPA device 202 may be managed or supervised by a hypervisor.

In the network environment 200 of FIG. 2, the SPPA device 202 is coupled to a plurality of server devices 204(1)-204(n) that hosts a plurality of databases 206(1)-206(n), and also to a plurality of client devices 208(1)-208(n) via communication network(s) 210. A communication interface of the SPPA device 202, such as the network interface 114 of the computer system 102 of FIG. 1, operatively couples and communicates between the SPPA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SPPA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SPPA devices that efficiently implement a method for facilitating automated predictive analytics of specified pools by using machine learning and artificial intelligence.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SPPA device 202 may be a standalone device or integrated with one or more other devices or apparatuses, such as one or more of the server devices 204(1)-204(n), for example. In one particular example, the SPPA device 202 may include or be hosted by one of the server devices 204(1)-204(n), and other arrangements are also possible. Moreover, one or more of the devices of the SPPA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SPPA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to bid lists, specified pools, pool characteristics, real-time market data, historical trade data, predicted amounts, shared attributes, pay-ups, and premiums.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SPPA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SPPA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SPPA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SPPA device 202, the server devices 204(1)-204(n), or the client devices 208(1)-208(n), for example, may be configured to operate as virtual instances on the same physical machine. In other words, one or more of the SPPA device 202, the server devices 204(1)-204(n), or the client devices 208(1)-208(n) may operate on the same physical device rather than as separate devices communicating through communication network(s) 210. Additionally, there may be more or fewer SPPA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

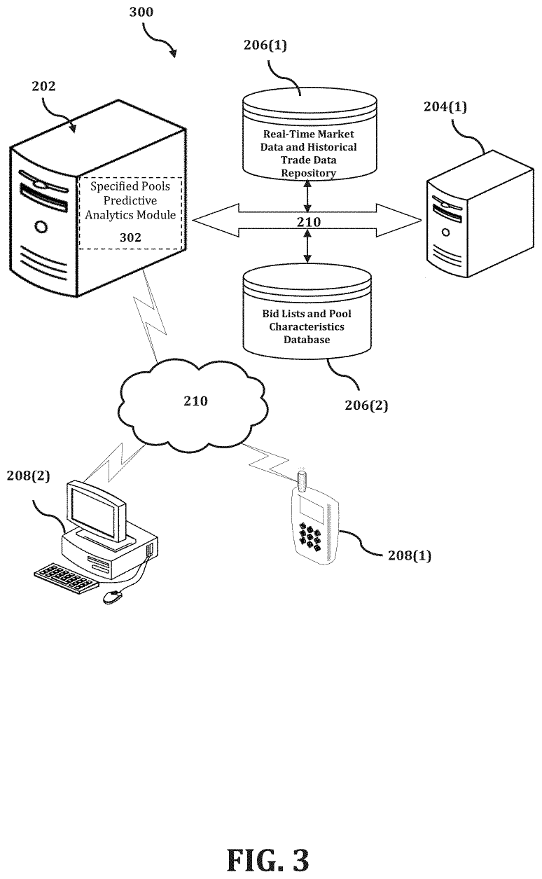

The SPPA device 202 is described and shown in FIG. 3 as including a specified pools predictive analytics module 302, although it may include other rules, policies, modules, databases, or applications, for example. As will be described below, the specified pools predictive analytics module 302 is configured to implement a method for facilitating automated predictive analytics of specified pools by using machine learning and artificial intelligence.

An exemplary process 300 for implementing a mechanism for facilitating automated predictive analytics of specified pools by using machine learning and artificial intelligence by utilizing the network environment of FIG. 2 is shown as being executed in FIG. 3. Specifically, a first client device 208(1) and a second client device 208(2) are illustrated as being in communication with SPPA device 202. In this regard, the first client device 208(1) and the second client device 208(2) may be “clients” of the SPPA device 202 and are described herein as such. Nevertheless, it is to be known and understood that the first client device 208(1) and/or the second client device 208(2) need not necessarily be “clients” of the SPPA device 202, or any entity described in association therewith herein. Any additional or alternative relationship may exist between either or both of the first client device 208(1) and the second client device 208(2) and the SPPA device 202, or no relationship may exist.

Further, SPPA device 202 is illustrated as being able to access a real-time market data and historical trade data repository 206(1) and a bid lists and pool characteristics database 206(2). The specified pools predictive analytics module 302 may be configured to access these databases for implementing a method for facilitating automated predictive analytics of specified pools by using machine learning and artificial intelligence.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SPPA device 202 via broadband or cellular communication. Of course, these embodiments are merely exemplary and are not limiting or exhaustive.

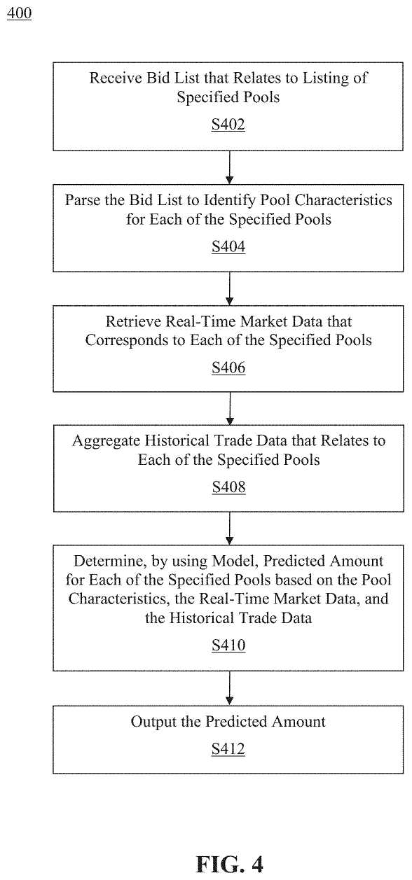

Upon being started, the specified pools predictive analytics module 302 executes a process for facilitating automated predictive analytics of specified pools by using machine learning and artificial intelligence. An exemplary process for facilitating automated predictive analytics of specified pools by using machine learning and artificial intelligence is generally indicated at flowchart 400 in FIG. 4.

In the process 400 of FIG. 4, at step S402, bid lists may be received from an exchange platform. The bid lists may be received via an application programming interface (API) and may relate to a listing of specified pools. In an exemplary embodiment, the bid lists may be automatically received based on a predetermined schedule from the exchange platform. For example, the bid lists may be automatically received at a certain time based on a daily schedule from the exchange platform. In another exemplary embodiment, the bid lists may be received ad hoc via a graphical user interface. For example, a user may utilize an integrated graphical user interface to input the bid lists as desired.

In another exemplary embodiment, the exchange platform may relate to computing software that enable users to place and/or receive orders for financial products such as, for example, placing bids for bonds over a network. The exchange platform may include first-party software such as, for example, internally operated software that manages transactions of financial instruments. The exchange platform may also include third-party software such as, for example, external software that is operated by a mortgage loan company that manages financial instrument transactions. In another exemplary embodiment, the financial instruments may include individually tradeable assets as well as a package of the tradable assets. For example, the individually tradeable asset may include mortgage-backed securities (MBS) and the package of the tradable assets may include a specified pool of MBS.

In another exemplary embodiment, the specified pools may include a plurality of financial instruments that are combined based on a shared attribute. The shared attribute may include at least one from among a credit score attribute, a loan size attribute, and a geographical distribution attribute.

In another exemplary embodiment, the specified pools may correspond to bonds that are created based on borrower traits such as, for example, a borrower's creditworthiness. The specified pools may be designed to provide enhanced certainty based on specificity of the underlying assets. In another exemplary embodiment, each of the specified pools may correspond to a mortgage pool that relates to a group of mortgages that are held in trust as collateral for the issuance of a mortgage-backed security. The mortgage pools may have shared characteristics such as, for example, issuance date and maturity date.

In another exemplary embodiment, each of the specified pools may correspond to a grouping of any financial instruments such as, for example, equity instruments, derivative instruments, and debt instruments with shared characteristics. The grouped financial instruments may be traded together as a tradable combination of the financial instruments. The grouped financial instruments may also be usable to represent a corresponding financial product such as, for example, a fixed-income instrument that represents a loan made by an investor to a borrower.

At step S404, the bid lists may be parsed to identify pool characteristics for each of the specified pools. In an exemplary embodiment, the pool characteristics may correspond to a shared feature of each financial instrument in the specified pools. For example, the pool characteristics may include a common maturity date that all of the financial instruments in the specified pools share. In another exemplary embodiment, the pool characteristics may include features of the specified pools. For example, the pool characteristic may include pool specific features such as a number of loans in the specified pools as well as a current balance of the specified pools.

In another exemplary embodiment, the pool characteristics may correspond to a machine learning and pattern recognition feature that relates to an individual measurable property of a phenomenon. The feature may include numeric features and structural features such as, for example, strings and graphs that are usable in syntactic pattern recognition. In another exemplary embodiment, the feature may correspond to an explanatory variable that is used in statistical analysis techniques. The explanatory variable may be weighted based on statistical contribution to a predicted outcome. For example, the explanatory variable that contributes significantly to the predicted outcome may be assigned a higher weighted factor than another explanatory variable that has a low contribution.

At step S406, real-time market data that corresponds to each of the specified pools may be retrieved. In an exemplary embodiment, the real-time market data may include data such as, for example, pricing data that relates to each financial instrument in the specified pools. For example, the real-time market data may include current pricing information for each of the financial instruments. In another exemplary embodiment, the real-time market data may include data for the specified pools. For example, the real-time market data may include pool specific market data such as a volatility variable of the specified pools.

In another exemplary embodiment the market data may be retrieved in real-time from a first-party source. For example, the market data may be retrieved from an internally operated trading venue of a financial institution. In another exemplary embodiment, the market data may be retrieved in real-time from a third-party source. For example, the market data may be retrieved from an externally operated trading venue such as a stock exchange. In another exemplary embodiment, the market data for a particular financial instrument may include an identifier that corresponds to the financial instrument. For example, the identifier may include an exchange code associated with the financial instrument. As will be appreciated by a person of ordinary skill in the art, the market data may include any raw data and structured data sets related to the financial instruments in the specified pools as well as the specified pool itself.

At step S408, historical trade data that relates to each of the specified pools may be aggregated. In an exemplary embodiment, the historical trade data may include trade information that corresponds to each financial instrument in the specified pools. For example, the historical trade data may include previous transaction information for each of the financial instruments. In another exemplary embodiment, the historical trade data may include trade information for the specified pools. For example, the historical trade data may include pool specific trade data such as a previous pay-up price of the specified pools. As will be appreciated by a person of ordinary skill in the art, the historical trade data may be aggregated from first-party sources as well as third-party sources.

At step S410, a predicted amount for each of the specified pools may be determined based on the identified pool characteristics, the retrieved real-time market data, and the aggregated historical trade data. The predicted amount may be determined for each of the specified pools by using a model. In an exemplary embodiment, the predicted amount may correspond to a predicted pay-up amount for the corresponding specified pools. The predicted pay-up amount may relate to an estimated premium over a generic to be announced (TBA) security price. In another exemplary embodiment, the predicted amount for each of the specified pools may be automatically determined and outputted in real-time in response to the received bid lists.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, K-fold cross-validation analysis, balanced class weight analysis, etc. In another exemplary embodiment, machine learning analytical techniques may include unsupervised learning algorithms such as, for example, Apriori analysis, K-means clustering analysis, isolation forest analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the model may be further trained by generating feedback data based on a predetermined parameter. The predetermined parameter may include a time parameter. For example, feedback data may be generated daily at the end of the day to account for predictions made in response to bid lists received. In another exemplary embodiment, the feedback data may include information that relates to the predicted amount, a transacted amount, and the corresponding specified pools. Consistent with disclosures in the present application, the transacted amount may relate to an actual pay-up amount for the corresponding specified pool in an executed transaction. Then, the model may be trained by using the feedback data.

At step S412, the predicted amount may be outputted to the exchange platform. The predicted amount may be outputted via the API in response to the received bid lists. Consistent with disclosures in the present application, the exchange platform may relate to computing software that enable users to place and/or receive orders for financial products such as, for example, placing bids for bonds over a network. The exchange platform may include first-party software such as, for example, internally operated software that manages transactions of financial instruments. The exchange platform may also include third-party software such as, for example, external software that is operated by a mortgage loan company that manages financial instrument transactions.

In another exemplary embodiment, information that relates to the specified pools may be documented by retrieving a transacted amount for the corresponding specified pools. The transacted amount may relate to an actual pay-up amount for the corresponding specified pools in an executed transaction. Then, reports may be generated based on a predetermined preference. The report may include information that relates to the predicted amount, the transacted amount, and the corresponding specified pools. In another exemplary embodiment, the predetermined preference may correspond to a user preference for receiving the report. For example, the user preference may indicate a desire to view the report after execution of the transaction for comparison of the actual pay-up amount with the corresponding predicted amount.

In another exemplary embodiment, the model may be benchmarked to determine performance and to facilitate further refinement. The model may be benchmarked based on the predicted amount and the transacted amount by using an error analysis algorithm. The error analysis algorithm may include at least one from among a mean absolute error algorithm and a root mean squared error algorithm. Then, the generated report may be updated to include a result of the benchmarking. In another exemplary embodiment, the generated report may be visually represented as a graphical element and displayed via a graphical user interface. The graphical element may correspond to a visual representation such as, for example, a chart of data from the report.

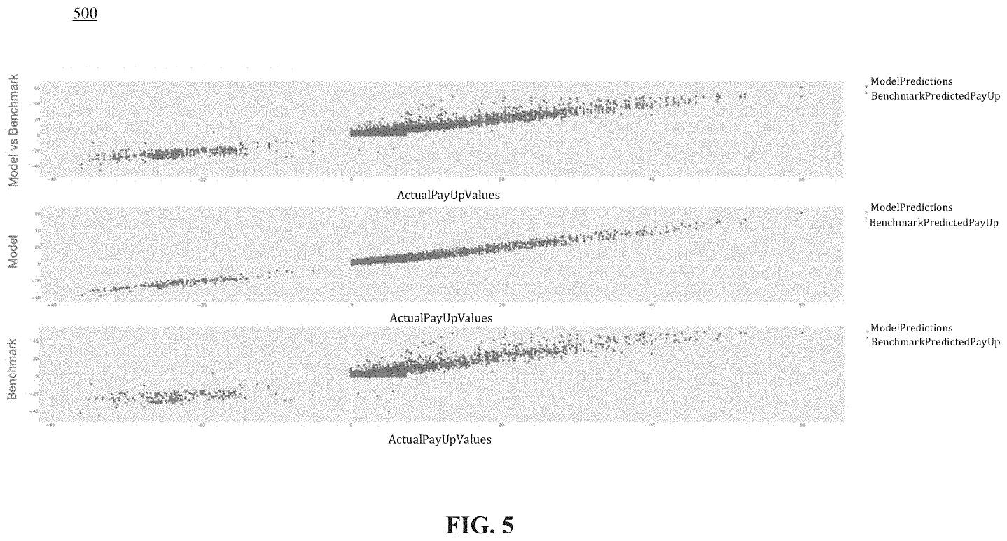

FIG. 5 is a screen shot 500 that illustrates a benchmark graphical user interface that is usable for implementing a method for facilitating automated predictive analytics of specified pools by using machine learning and artificial intelligence, according to an exemplary embodiment. In FIG. 5, a visual comparison between the model predictions and actual pay-up values may be facilitated to benchmark the model for specified pools.

As illustrated in FIG. 5, data points may be generated on a scatterplot to visually represent model performance. The second scatterplot titled “model” may include a set of data points that visually represent model predictions for corresponding specified pools. The third scatterplot titled “benchmark” may include a set of data points that visually represent actual pay-up values for the corresponding specified pools. The first scatterplot, which is a combination of the data points in both the second scatterplot and the third scatterplot, enables a quick visual comparison between the model predictions and the actual pay-up values.

In another exemplary embodiment, a relative distance between a particular model prediction point and a corresponding actual pay-up value may be used to calculate an accuracy percentage. As such, variables for the specified pools such as, for example, particular pool characteristics may be adjusted to improve an existing accuracy percentage as well as to match a desired accuracy percentage.

Accordingly, with this technology, an optimized process for facilitating automated predictive analytics of specified pools by using machine learning and artificial intelligence is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for facilitating automated predictive analytics of a plurality of specified pools, the method being implemented by at least one processor, the method comprising:
generating, by the at least one processor, at least one model by using an artificial neural network;
training, by the at least one processor using training data, the at least one model;
assessing, by the at least one processor, the at least one model to determine whether at least one rate is within a predetermined range;
deploying, by the at least one processor, the at least one model based on a result of the assessment;
receiving, by the at least one processor via an application programming interface, at least one bid list from at least one exchange platform, the at least one bid list relating to a listing of at least one specified pool;
parsing, by the at least one processor, the at least one bid list to identify at least one pool characteristic for each of the at least one specified pool,
wherein the at least one pool characteristic corresponds to a machine learning pattern recognition feature that relates to an individual measurable property of a phenomenon;
retrieving, by the at least one processor, real-time market data that corresponds to each of the at least one specified pool;
aggregating, by the at least one processor, historical trade data that relates to each of the at least one specified pool;
determining, by the at least one processor in real-time using the at least one model, a predicted amount for each of the at least one specified pool based on the identified at least one pool characteristic, the retrieved real-time market data, and the aggregated historical trade data; and
outputting, by the at least one processor in real-time via the application programming interface, the predicted amount to the at least one exchange platform.

2. The method of claim 1, wherein the at least one specified pool includes a plurality of financial instruments that are combined based on at least one shared attribute, the at least one shared attribute including at least one from among a credit score attribute, a loan size attribute, and a geographical distribution attribute.

3. The method of claim 1, wherein the predicted amount corresponds to a predicted pay-up amount for the corresponding at least one specified pool, the predicted pay-up amount relating to an estimated premium over a generic to be announced security price.

4. The method of claim 1, further comprising:
retrieving, by the at least one processor, a transacted amount for the corresponding at least one specified pool, the transacted amount relating to an actual pay-up amount for the corresponding at least one specified pool in an executed transaction; and
generating, by the at least one processor, at least one report based on a predetermined preference, the at least one report including information that relates to the predicted amount, the transacted amount, and the corresponding at least one specified pool.

5. The method of claim 4, further comprising:
benchmarking, by the at least one processor using at least one error analysis algorithm, the at least one model based on the predicted amount and the transacted amount, the at least one error analysis algorithm including at least one from among a mean absolute error algorithm and a root mean squared error algorithm; and
updating, by the at least one processor, the at least one report to include a result of the benchmarking.

6. The method of claim 1, further comprising:
generating, by the at least one processor, feedback data based on a predetermined parameter, the predetermined parameter including a time parameter; and
training, by the at least one processor, the at least one model by using the feedback data.

7. The method of claim 6, wherein the feedback data includes information that relates to the predicted amount, a transacted amount, and the corresponding at least one specified pool, the transacted amount relating to an actual pay-up amount for the corresponding at least one specified pool in an executed transaction.

8. The method of claim 1, wherein the predicted amount for each of the at least one specified pool is automatically determined and outputted in real-time in response to the received at least one bid list.

9. The method of claim 1, wherein the at least one model includes at least one from among a machine learning model, a mathematical model, a process model, and a data model.

10. A computing device configured to implement an execution of a method for facilitating automated predictive analytics of a plurality of specified pools, the computing device comprising:
a processor;
a memory; and
a communication interface coupled to each of the processor and the memory,
wherein the processor is configured to:
generate at least one model by using an artificial neural network;
train, by using training data, the at least one model;
assess the at least one model to determine whether at least one rate is within a predetermined range;
deploy the at least one model based on a result of the assessment;
receive, via an application programming interface, at least one bid list from at least one exchange platform, the at least one bid list relating to a listing of at least one specified pool;
parse the at least one bid list to identify at least one pool characteristic for each of the at least one specified pool,
wherein the at least one pool characteristic corresponds to a machine learning pattern recognition feature that relates to an individual measurable property of a phenomenon;
retrieve real-time market data that corresponds to each of the at least one specified pool;
aggregate historical trade data that relates to each of the at least one specified pool;
determine, in real-time by using the at least one model, a predicted amount for each of the at least one specified pool based on the identified at least one pool characteristic, the retrieved real-time market data, and the aggregated historical trade data; and
output, in real-time via the application programming interface, the predicted amount to the at least one exchange platform.

11. The computing device of claim 10, wherein the at least one specified pool includes a plurality of financial instruments that are combined based on at least one shared attribute, the at least one shared attribute including at least one from among a credit score attribute, a loan size attribute, and a geographical distribution attribute.

12. The computing device of claim 10, wherein the predicted amount corresponds to a predicted pay-up amount for the corresponding at least one specified pool, the predicted pay-up amount relating to an estimated premium over a generic to be announced security price.

13. The computing device of claim 10, wherein the processor is further configured to:
retrieve a transacted amount for the corresponding at least one specified pool, the transacted amount relating to an actual pay-up amount for the corresponding at least one specified pool in an executed transaction; and
generate at least one report based on a predetermined preference, the at least one report including information that relates to the predicted amount, the transacted amount, and the corresponding at least one specified pool.

14. The computing device of claim 13, wherein the processor is further configured to:
benchmark, by using at least one error analysis algorithm, the at least one model based on the predicted amount and the transacted amount, the at least one error analysis algorithm including at least one from among a mean absolute error algorithm and a root mean squared error algorithm; and
update the at least one report to include a result of the benchmarking.

15. The computing device of claim 10, wherein the processor is further configured to:
generate feedback data based on a predetermined parameter, the predetermined parameter including a time parameter; and
train the at least one model by using the feedback data.

16. The computing device of claim 15, wherein the feedback data includes information that relates to the predicted amount, a transacted amount, and the corresponding at least one specified pool, the transacted amount relating to an actual pay-up amount for the corresponding at least one specified pool in an executed transaction.

17. The computing device of claim 10, wherein the processor is further configured to automatically determine and output the predicted amount for each of the at least one specified pool in real-time in response to the received at least one bid list.

18. The computing device of claim 10, wherein the at least one model includes at least one from among a machine learning model, a mathematical model, a process model, and a data model.

19. A non-transitory computer readable storage medium storing instructions for facilitating automated predictive analytics of a plurality of specified pools, the storage medium comprising executable code which, when executed by a processor, causes the processor to:
generate at least one model by using an artificial neural network;
train, by using training data, the at least one model;
assess the at least one model to determine whether at least one rate is within a predetermined range;
deploy the at least one model based on a result of the assessment;
receive, via an application programming interface, at least one bid list from at least one exchange platform, the at least one bid list relating to a listing of at least one specified pool;
parse the at least one bid list to identify at least one pool characteristic for each of the at least one specified pool,
wherein the at least one pool characteristic corresponds to a machine learning pattern recognition feature that relates to an individual measurable property of a phenomenon;
retrieve real-time market data that corresponds to each of the at least one specified pool;
aggregate historical trade data that relates to each of the at least one specified pool;
determine, in real-time by using the at least one model, a predicted amount for each of the at least one specified pool based on the identified at least one pool characteristic, the retrieved real-time market data, and the aggregated historical trade data; and
output, in real-time via the application programming interface, the predicted amount to the at least one exchange platform.

20. The storage medium of claim 19, wherein the at least one specified pool includes a plurality of financial instruments that are combined based on at least one shared attribute, the at least one shared attribute including at least one from among a credit score attribute, a loan size attribute, and a geographical distribution attribute.
